(19) United States
(12) Patent Application Publication
(10) Pub. No.: US 2010/0002593 A1
(43) Pub. Date: Jan. 7, 2010

(54) METHOD FOR DETECTING FAULTS IN GATEWAY

(75) Inventor: WEN-YUAN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/255,646

(22) Filed: Oct. 21, 2008

(30) Foreign Application Priority Data
Jul. 4, 2008 (CN) 200810302532.5

(51) Int. Cl. H04L 12/26

(52) U.S. Cl. 370/242

(57) ABSTRACT

A method for detecting gateway (100) faults comprising providing a gateway, including a protection line card (30) and at least one Voice over Internet Protocol (VoIP) line card (20), each VoIP line card having a corresponding adaptor card (21), if a working VoIP line card fails, switching the failed VoIP line card to standby status, and activating the protection line card to assume duties of the failed VoIP line card, using the VoIP line card in standby status to detect its corresponding adaptor card, and determining current working status of the active protection line card according to the detection results.

### BACKGROUND OF THE INVENTION

1. Field of the Invention

The present invention generally relates to methods for detecting gateway faults, particularly to a method for detecting faults of adaptor cards in gateways.

2. Description of related art

Many types of line cards are employed in gateways. For example, a conventional AG5000 gateway includes two management line cards (MCP), two public switch telephone networks (PSTN) switching line card (TDSW), and 13 Voice over Internet Protocol (VoIP) line cards. Each VoIP line card has a corresponding adaptor card, through which each VoIP line card is connected to its subscriber. Thus, the gateway can transmit audio signals from the Internet or PSTN to the subscriber.

Generally, an additional VoIP line card is set as a protection card in the gateway. When other VoIP line cards are operating properly, the protection line card is in standby status. If one working VoIP line card fails, an MCP can switch duties of the failed VoIP line card to the protection line card. Thus, the protection line card becomes active and assumes the duties of the failed VoIP line card. At the same time, the failed VoIP line card goes into standby status to await repair.

In conventional gateways, protection line cards usually do not have automatic fault detection and alarm capability to prevent interruption of gateway function. As a result, many gateways may suffer when a standby protection line card assumes duties of a failed VoIP line card and cannot detect the adaptor card corresponding to the failed VoIP line card. When the protection line card assumes function of the failed VoIP line card without recognition of the corresponding adaptor card or no connection thereof to the network or PSTN, faults and errors may be generated in the gateway.

Therefore, a method for detecting gateway adaptor card faults is desired in order to overcome the described limitations.

### BRIEF DESCRIPTION OF THE DRAWINGS

Many aspects of the method for detecting gateway faults can be better understood with references to the following drawings. The components in the drawings are not necessarily drawn to scale, the emphasis instead being placed upon clearly illustrating the principles of the new method for detecting gateway faults. Moreover, in the drawings, like reference numerals designate corresponding parts throughout the several views.

FIG. 1 is a diagram of a gateway employing a method for detecting gateway faults according to an exemplary embodiment.

FIG. 2 is a flowchart of the method for detecting gateway faults, according to the exemplary embodiment.

### DETAILED DESCRIPTION OF THE INVENTION

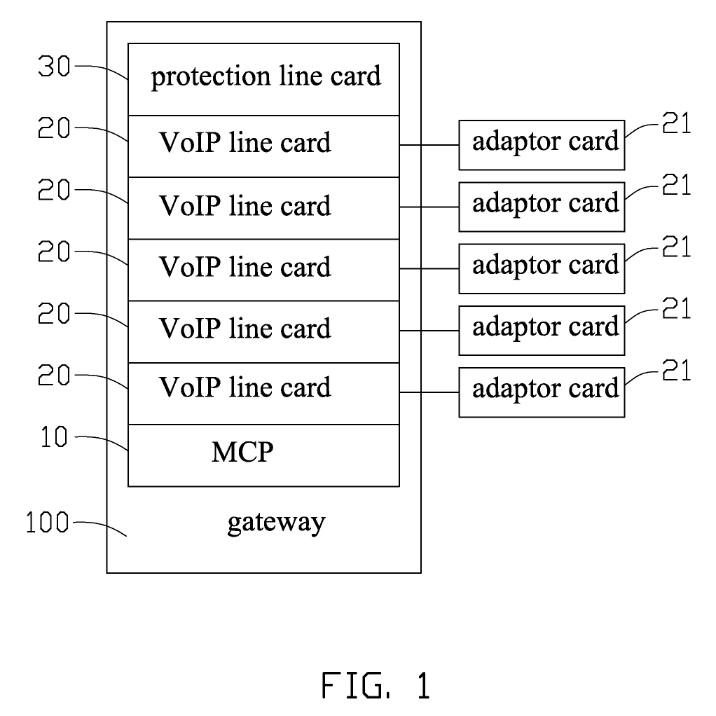

In an exemplary embodiment of a method for detecting gateway faults, as shown in FIG. 1, a gateway 100 includes at least one management line card (MCP) 10, a plurality of Voice over Internet Protocol (VoIP) line cards 20, and at least one protection line card 30. The VoIP line cards 20 and the protection line card 30 are all connected to the MCP 10 and controlled thereby. Each VoIP line card 20 has a corresponding adaptor card 21, and each VoIP line card 20 connects with the Internet or public switch telephone network (PSTN) via the corresponding adaptor card 21. When any of the VoIP line cards 20 fails, the MCP 10 switches the duties of the failed VoIP line card 20 to the protection line card 30. The protection line card 30 assumes duties of the failed VoIP line card 20, which enters standby status.

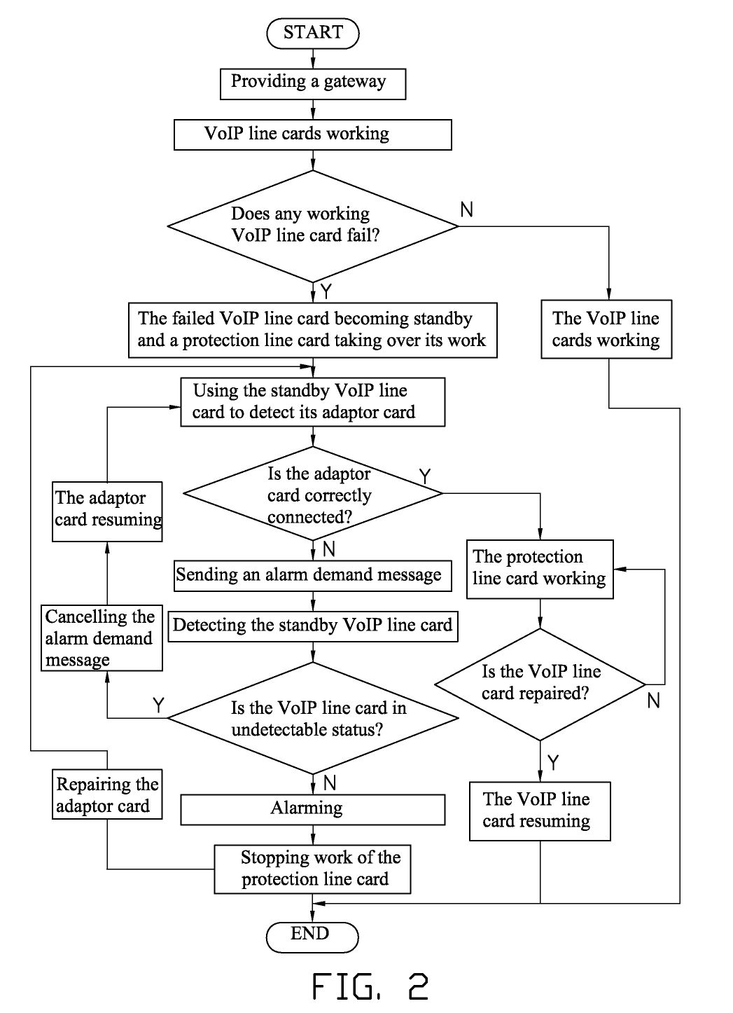

Also referring to FIG. 2, a method for detecting faults of adaptors 21 in the gateway 100, according to the exemplary embodiment, is provided.

In the method, an aforementioned gateway 100 is provided. When the gateway 100 is used, at least one of the VoIP line cards 20 of the gateway 100 connects with the Internet or PSTN via its corresponding adaptor card 21. The protection line card 30 is set to standby status. The MCP 10 detects the working VoIP line cards 20 and deals with faults of the VoIP line cards 20.

If any of the working VoIP line cards 20 fails, the failed VoIP line card 20 enters standby status, and the MCP 10 activates the protection line card 30 to assume duties of the failed VoIP line card 20.

When the protection line card 30 replaces the VoIP line card 20 in standby status, the standby VoIP line card 20 detects a corresponding adaptor card 21. The MCP 10 determines the working status of the active protection line card 30 according to the detection results.

For the gateway 100 to detect the corresponding adaptor card 21 of the VoIP line card 20 in standby status, the MCP 10 sends detecting instructions to control the VoIP line card 20 in standby status to detect its corresponding adaptor card 21. If the VoIP line card 20 in standby status detects that the adaptor card 21 is correctly connected thereto, the VoIP line card 20 in standby status sends a response message to the MCP 10. The MCP 10 then connects the protection line card 30 to the adaptor card 21 to replace the VoIP line card 20 in standby status. Until the VoIP line card 20 in standby status is repaired, the MCP 10 connects the VoIP line card 20 to the adaptor card 21 to continue work, and resumes the protection card 30 to standby status.

The VoIP line card 20 in standby status sends a warning message to the MCP 10 if it detects that the adaptor card 21 is absent or otherwise non-functional, for example, damaged or interrupted. The MCP 10 checks a status of the VoIP line card 20 in standby status upon receiving the warning message, and determines whether to generate an alarm according to the checking results.

If the MCP 10 that received the warning message finds that the VoIP line card 20 in standby status has assumed detectable status, it determines that the adaptor card 21 corresponding to the VoIP line card 20 in standby status is absent or otherwise non-functional. Thus, the MCP 10 issues an alert or directs the protection line card 30 to do so, such that the absent or failed adaptor card 21 is remedied in a timely manner. After issuing an alert, the MCP 10 can also stop and/or cancel work of the protection line card 30 to prevent faults and errors caused in the gateway 100. After the adaptor card 21 has been repaired and is correctly connected to the VoIP line card 20 in standby status, the protection card 30 can continue to assume work of the VoIP line card 20 in standby status according to the described means.

When the VoIP line card 20 in standby status is undetectable, such as in reboot, open circuit, or having been removed, among others, the corresponding adaptor card 21 of the VoIP line card 20 in standby status cannot be detected. However, the MCP 10, receiving the message that the VoIP line card 20 in standby status is undetectable, refrains from issuing an alert until ascertaining whether the line card 20 is only temporarily unavailable due to reboot or open circuit conditions, and keeps the protection line card in working status. After the VoIP line card 20 in standby status returns to detectable status, for example, when reboot has completed or charging, the MCP 10 checks the VoIP line card 20 in standby status again to determine its corresponding adaptor card 21 status.

Understandably, the functions of the MCP 10 can also be completed by other data processors connected to the gateway 100, such as computers, single chips or microprocessors, or others.

In the present method according to the exemplary embodiment, when the protection line card 30 assumes duties of a failed VoIP line card 20, the failed VoIP line card 20 goes into standby status and is used to detect absence and faults of its corresponding adaptor card 21. Working status of the active protection line card 30 can be determined according to the detection results. Compared with other methods, the present method can prevent the protection line card 30 from performing the duties of the failed VoIP line card 20 in cases where the adaptor card 21 of the failed VoIP line card 20 is absent or in other unfavorable status. As a result, faults and errors are decreased in use of the gateway 100.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for detecting gateway faults, comprising:
providing a gateway including a protection line card and at least one Voice over Internet Protocol (VoIP) line card, each VoIP line card comprising a corresponding adaptor card;
using at least one VoIP line card;
wherein, if a working VoIP line card fails, the failed VoIP line card is switched to standby status, and the protection line card is activated to assume duties of the failed VoIP line card;
checking the standby VoIP line card to determine the status of its corresponding adaptor card; and
determining latter working status of the active protection line card according to the detection results.

2. The method as claimed in claim 1, further comprising replacing the VoIP line card in standby status with the protection line card.

3. The method as claimed in claim 2, further comprising connecting the VoIP line card in standby status to its adaptor card to continue functioning after the standby VoIP line card has been repaired, and returning the protection card to standby status.

4. The method as claimed in claim 1, further comprising the VoIP line card in standby status issuing an alert to a management line card (MCP) if it detects that its adaptor card is absent or unresponsive.

5. The method as claimed in claim 4, further comprising checking a status of the VoIP line card in standby status when the MCP receives the warning message, and determining if an alarm is generated according the checking results.

6. The method as claimed in claim 5, further comprising issuing an alert if the VoIP line card in standby status resumes detectable status.

7. The method as claimed in claim 6, further comprising stopping and/or canceling function of the protection line card after an alert is issued.

8. The method as claimed in claim 5, further comprising canceling the alarm message and maintaining the protection line card in working status if the VoIP line card in standby status assumes undetectable status.

9. The method as claimed in claim 8, further comprising using the standby VoIP line card to detect its adaptor card again after the VoIP line card in standby status transitions into a detectable status.
